(19) United States
(12) Patent Application Publication
(10) Pub. No.: US 2019/0073127 A1
(43) Pub. Date: Mar. 7, 2019

(54) BYTE ADDRESSABLE MEMORY SYSTEM FOR A NEURAL NETWORK AND METHOD THEREOF

(71) Applicant: Anil Ravindranath, Sunnyvale, CA (US)

(72) Inventor: Anil Ravindranath, Sunnyvale, CA (US)

(73) Assignee: Rapt.ai Inc., Santa Clara, CA (US)

(21) Appl. No.: 16/180,658

(22) Filed: Nov. 5, 2018

(51) Int. Cl. G06F 3/06; G06N 3/02

(52) U.S. Cl. CPC G06F 3/0604; G06N 3/02; G06F 3/0673; G06F 3/0638

(57) ABSTRACT

A system and method for providing a byte addressable memory for a neural network. The method comprises a step of initiating reading and writing input-output (I/O) request of a file through a neural network application. The method then accesses the file through POSIX APIs. The method maps the accessed file to bytes of a primary memory unit by utilizing load/store CPU instructions. The method maps the bytes to a secondary memory unit through an MMU. The method transmits instructions to a persistent memory aware file system with the MMU mappings and then the instructions are transmitted to the persistent unit. The method receives the reading and writing I/O request from the persistent unit through VFIO driver. The method receives the reading and writing I/O request from VFIO driver through DMA. The method then receives the reading and writing I/O request from the DMA through a memory pertaining to coprocessors.

### FIELD OF INVENTION

The present invention relates to neural networks, in particular to a byte addressable memory system for a neural network.

### BACKGROUND

Typically, neural networks mimic any continuous function. But many times training neural networks (supervised training from random initialization) is more difficult when the network is deep (3, 4 or 5 layers) as compared to the shallow network (1 or 2 layers). Neural Network training is a pretty time-consuming process which requires huge amounts of data for model prediction accuracy. To crunch more and more data, it needs expensive coprocessor to compute resources (GPU, TPU, custom FPGAs).Computer coprocessors like GPUs are pretty fast which can crunch data in TFLOPS to PFLOPS speed, but GPUs have very less memory onboard. Neural networks use containers (multiple isolated operating systems) to scale and run the training quickly.

Currently, the “input data” is passed from the outside of the container and “hyperparameter transactions”, between a host and containers. The data is passed as “blocks”. Block-based I/O access is “slow” compared to a byte addressable. Byte addressable IO is done in microseconds to nanoseconds, whereas block based IO takes higher microseconds to milliseconds to complete. Typically, the coprocessors (GPUs) are occupied while training and inference the neural networks. All data is read from disks which become the bottleneck. To make sure disk is not the bottleneck, GPUs do have onboard GDDR memory which has data ready for GPU cores. But this GDDR memory is very small and cannot fit in all Input data. Hence neural networks rely on Disk storage to transfer input data and hyperparameter updates. Disk storage may not necessarily be local/direct attached. If accessed over the network it will add more transfer delays.

US patent application20180165575A1 filed by Henry; G. Glenn et al. discloses a neural network unit. It comprises first and second random access memory (RAIVI),It further includes an array of N neural processing units (NPU) configured to concurrently receive 2N bytes from a row of the first RAM and receive 2N bytes from a row of the second RAM. Each NPU of the array receives respective first upper, and lower bytes of the 2N bytes received from the first RAM and receives respective second upper and lower bytes of the 2N bytes received from the second RAM. When in a first mode, each NPU of the array sign extends the first upper byte to form a first 16-bit word and performs an arithmetic operation on the first 16-bit word and a second 16-bit word formed by the second upper and lower bytes. When in a second mode, each NPU of the array sign extends the first lower byte to form a third 16-bit word and performs the arithmetic operation on the third 16-bit word and the second 16-bit word formed by the second upper and lower bytes. When in a third mode, each NPU of the array performs the arithmetic operation on a fourth 16-bit word formed by the first upper and lower bytes and the second 16-bit word formed by the second upper and lower bytes.

The existing solutions use disks for reads/write with system DRAM to page cache the data which helps in faster access. This solution has the following issues: 1) Disk access for neural networks are done as file operations from the application in neural network and mapped to blocks on the disk. This is a standard way for an application to access the disk. This uses complete software stack in the operating system which involves block layers, schedulers in the kernel which add undue latencies for IO operation. 2) Memory pressure—To speed up the disk, typically memory management in an operating system use page cache to cache the reads/writes from memory directly and later flush into a disk. The issue with this approach is a file to page mapping, and constant page flushes continuously. This page flush is a costly process and adds delay to the overall IO flow to the Neural Network application. 3) DRAM/System memory is usually low in capacity (lower GBs) and very expensive. Since neural network data is typically big, spanning from GBs to TBs, all neural network data cannot be accommodated into this system memory. Hence a user cannot rely on the system memory for caching when data is huge. 4) Neural Networks training is run inside a “container”. The input data and hyperparameters are transferred to GPU using “block based” options with system DRAM as page cache. Now due to block-based access, there is a conversion from page cache which is byte addressable to block. This conversion leads to “slowness” inside the container data access.

There is a need for an efficient, elegant and effective solution to provide an end to end Byte addressable I/O for neural networks. Further, there is a need for a system and method to map the read and write requests from the neural networks to bytes using load/store CPU instructions in memory instead of the blocks.

Thus, in view of the above, there is a long-felt need in the industry to address the aforementioned deficiencies and inadequacies.

Further limitations and disadvantages of conventional and traditional approaches will become apparent to one of skill in the art through comparison of described systems with some aspects of the present disclosure, as set forth in the remainder of the present application and with reference to the drawings.

All publications herein are incorporated by reference to the same extent as if each publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

As used in the description herein and throughout the claims that follow, the meaning of “a,” “an,” and “the” includes plural reference unless the context dictates otherwise. Also, as used in the description herein, the meaning of “in” includes “in” and “on” unless the context dictates otherwise.

### SUMMARY

The present invention mainly solves the technical problems existing in the prior art. In response to these problems, the present invention provides a system and method for providing a byte addressable memory for a neural network.

An aspect of the present disclosure relates to a method for providing a byte addressable memory for a neural network. The method comprises a step of initiating reading and writing input-output (I/O) request of a file through a neural network application. The method then comprises a step of accessing the file through a portable operating system interface (POSIX) APIs. The method then includes a step of mapping the accessed file to a plurality of bytes of a primary memory unit by utilizing a plurality of load/store CPU instructions. In an aspect, the primary memory unit is directly mapped to the coprocessor memory. Examples of the primary memory unit include but not limited to a system DRAM, persistent memory, non-volatile memory, storage class memory, etc.

Further, the method includes the step of mapping the bytes to a secondary memory unit through a memory management unit (MMU). The secondary memory unit is created from a persistent unit. Furthermore, the method comprises a step of transmitting a plurality of instructions to a persistent memory aware file system with the MMU mappings, and then the instructions are transmitted to the persistent unit. The method then includes the step of receiving the reading and writing input-output (I/O) request from the persistent unit through a Virtual Function I/O (VFIO) driver. The method includes the step of receiving the reading and writing input-output (I/O) request from the Virtual Function I/O (VFIO) driver through direct memory access (DMA). The method then includes the step of receiving the reading and writing input-output (I/O) request from the direct memory access (DMA) through a memory pertaining to one or more coprocessors.

In an aspect, the neural network application, the portable operating system interface (POSIX) APIs, and the persistent memory are contained in a neural network container.

In an aspect, the secondary memory unit is a rapt memory driver.

In an aspect, the rapt memory driver creates a memory device in a host operating system (OS).

In an aspect, the persistent memory is configured for a file system using a fourth extended file system (ext4) to create a persistent memory file system on the memory device.

In an aspect, the neural network container receives a memory mapped library from the memory device to train and inference the neural network.

An aspect of the present disclosure relates to a byte addressable memory system for a neural network. The system includes a processor and a memory.The memory stores machine-readable instructions that when executed by the processor cause the processor to initiate reading and writing input-output (I/O) request of a file through a neural network application. The processor is further configured to access the file through a portable operating system interface (POSIX) APIs. Further, the processor is configured to map the accessed file to a plurality of bytes of a primary memory unit by utilizing a plurality of load/store CPU instructions.

Furthermore, the processor is configured to map the bytes to a secondary memory unit through a memory management unit (MMU). The secondary memory unit is created from a persistent unit. The processor is then configured to transmit a plurality of instructions to a persistent memory aware file system with the MMU mappings, and then the instructions are transmitted to the persistent unit. Then the processor is configured to receive the reading and writing input-output (I/O) request from the persistent unit through a Virtual Function I/O (VFIO) driver.

The processor is then configured to receive the reading and writing input-output (I/O) request from the Virtual Function I/O (VFIO) driver through direct memory access (DMA). Further, the processor is configured to receive the reading and writing input-output (I/O) request from the direct memory access (DMA) through a memory pertaining to one or more coprocessors

An aspect of the present disclosure relates to a device in a network. The device includes a non-transitory storage device having embodied therein one or more routines operable to provide a byte addressable memory for a neural network.The device further includes one or more processors coupled to the non-transitory storage device and operable to execute the one or more routines. The one or more routines perform a step of initiating reading and writing input-output (I/O) request of a file through a neural network application. Then the routing is configured to perform a step of accessing the file through a portable operating system interface (POSIX) APIs.

Further, the routine is configured to perform a step of mapping the accessed file to a plurality of bytes of a primary memory unit by utilizing a plurality of load/store CPU instructions. The primary memory unit is a persistent memory. The routine is further configured to perform a step of mapping the bytes to a secondary memory unit through a memory management unit (MMU). The secondary memory unit is created from a persistent unit.

Furthermore, the routine is configured to perform a step of transmitting a plurality of instructions to a persistent memory aware file system with the MMU mappings and then the instructions are transmitted to the persistent unit. The routine is then configured to perform a step of receiving the reading and writing input-output (I/O) request from the persistent unit through a Virtual Function I/O (VFIO) driver. The routine is configured to perform a step of receiving the reading and writing input-output (I/O) request from the Virtual Function I/O (VFIO) driver through direct memory access (DMA). Further, the routine is configured to perform a step of receiving the reading and writing input-output (I/O) request from the direct memory access (DMA) through a memory pertaining to one or more coprocessors.

Accordingly, one advantage of the present invention is that it enables the neural networks to use the load/store CPU instructions by directly memory-mapping files.

Accordingly, one advantage of the present invention is that it performs faster reads and writes I/O from the neural networks to coprocessors such as GPU, TPU, FPGAs, etc.

Accordingly, one advantage of the present invention is that it bypasses the operating system and kernel layers such as block, schedulers,etc.

Accordingly, one advantage of the present invention is that it does not create any page cache and flush operations from the system memory.

Accordingly, one advantage of the present invention is that the stored data is non-volatile due to the compatibility of the persistent memory is.

Accordingly, one advantage of the present invention is that it can store huge amounts of data as persistent memory is bigger than system memory.

Other features of embodiments of the present disclosure will be apparent from accompanying drawings and from the detailed description that follows.

### BRIEF DESCRIPTION OF THE DRAWINGS

In the figures, similar components and/or features may have the same reference label. Further, various components of the same type may be distinguished by following the reference label with a second label that distinguishes among the similar components. If only the first reference label is used in the specification, the description applies to any one of the similar components having the same first reference label irrespective of the second reference label.

FIG. 1 illustrates a flowchart of the present method for providing a byte addressable memory for a neural network, in accordance with at least one embodiment.

FIG. 2 illustrates an operational flowchart of the present byte addressable memory system for a neural network, in accordance with at least one embodiment.

FIG. 3 illustrates an exemplary flowchart of the Rapt.ai byte addressable neural network container, in accordance with at least one embodiment.

### DETAILED DESCRIPTION

Systems and methods are disclosed for providing a byte addressable memory for a neural network. Embodiments of the present disclosure include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, firmware, and/or by human operators.

Embodiments of the present disclosure may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more machine-readable storage media containing the code according to the present disclosure with appropriate standard computer hardware to execute the code contained therein. An apparatus for practicing various embodiments of the present disclosure may involve one or more computers (or one or more processors within a single computer) and storage systems containing or having network access to computer program(s) coded in accordance with various methods described herein, and the method steps of the disclosure could be accomplished by modules, routines, subroutines, or subparts of a computer program product.

The present invention discloses an end to end byte addressable memory system for a neural network whereby the system and method map the read and writes requests from the neural networks to bytes using load/store CPU instructions in memory instead of the blocks.

Although the present disclosure has been described with the purpose ofproviding a byte addressable memory for a neural network, it should be appreciated that the same has been done merely to illustrate the invention in an exemplary manner and any other purpose or function for which explained structures or configurations could be used, is covered within the scope of the present disclosure.

Exemplary embodiments will now be described more fully hereinafter with reference to the accompanying drawings, in which exemplary embodiments are shown. This invention may, however, be embodied in many different forms and should not be construed as limited to the embodiments set forth herein. These embodiments are provided so that this disclosure will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular name.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail to avoid obscuring the embodiments.

The term “machine-readable storage medium” or “computer-readable storage medium” includes, but is not limited to, portable or non-portable storage devices, optical storage devices, and various other mediums capable of storing, containing, or carrying instruction(s) and/or data. A machine-readable medium may include a non-transitory medium in which data can be stored, and that does not include carrier waves and/or transitory electronic signals propagating wirelessly or over wired connections. Examples of a non-transitory medium may include but are not limited to, a magnetic disk or tape, optical storage media such as compact disk (CD) or versatile digital disk (DVD), flash memory, memory or memory devices.

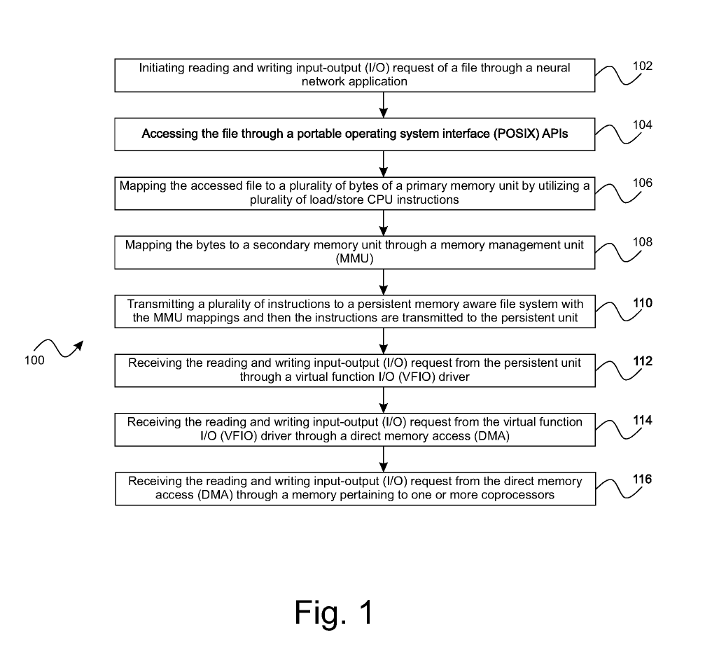

FIG. 1 illustrates a flowchart 100 of the present method for providing a byte addressable memory for a neural network, in accordance with at least one embodiment. The method comprises a step 102 of initiating reading and writing input-output (I/O) request of a file through a neural network application. Examples of the neural network applications include but not limited to “Image recognition”, “stock prediction”, “text to speech or speech to text processing”. The method then comprises a step 104 of accessing the file through a portable operating system interface (POSIX) APIs. Portable operating system interface (POSIX) is a set of standard operating system interfaces based on the UNIX operating system. POSIX defines an interface between programs and operating systems.

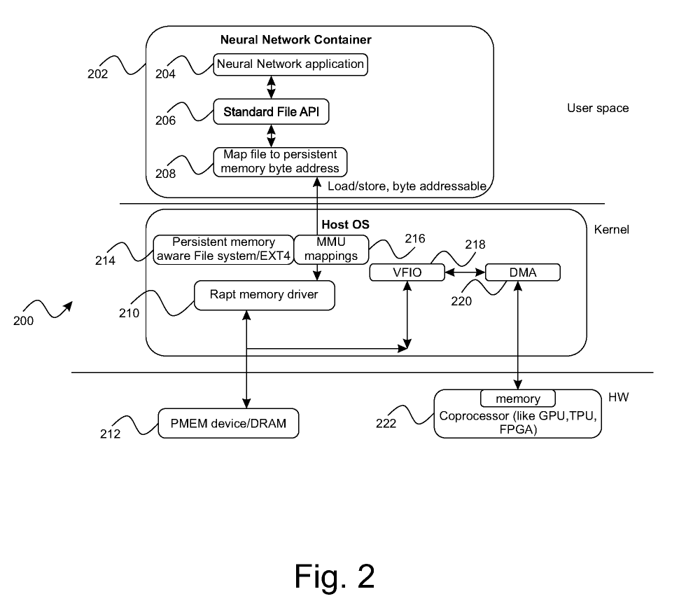

The method then includes a step 106 of mapping the accessed file to a plurality of bytes of a primary memory unit by utilizing a plurality of load/store CPU instructions. The load/store CPU instructions utilize load/store architecture which is an instruction set architecture that divides instructions into two categories: memory access (load and store between memory and registers), and ALU operations (which only occur between registers),In an embodiment, the neural network applications utilize a new NVM (Non-Volatile memory) supported load/store CPU instructions to access persistent data stored in DRAM, persistent memory directly, SCMs(Storage Class Memory), etc. In an embodiment, the primary memory unit is directly mapped to the coprocessor memory. Examples of the primary memory unit include but is not limited to a system DRAM, persistent memory, non-volatile memory, storage class memory, etc. In an embodiment, the neural network application, the portable operating system interface (POSIX) APIs, and the persistent memory are contained in a neural network container 202 (shown in FIG. 2).

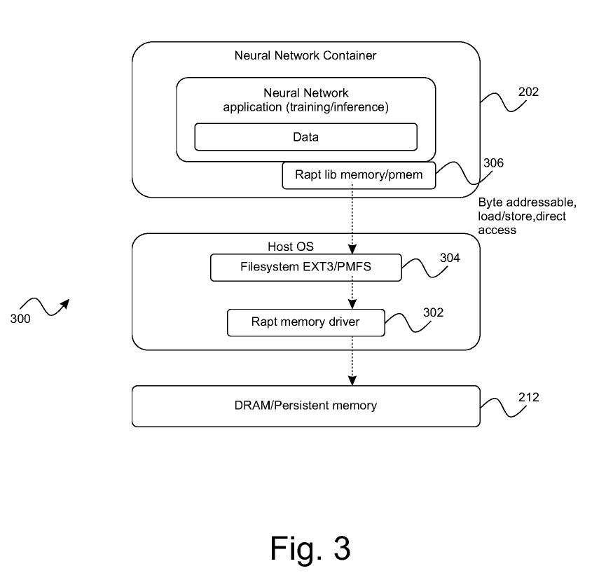

Further, the method includes the step 108 of mapping the bytes to a secondary memory unit through a memory management unit (MMU). The secondary memory unit is created from a persistent unit. In an embodiment, the secondary memory unit is a rapt memory driver 302 (shown in FIG. 3). In an embodiment, the rapt memory driver 302 provides either a partition of a DRAM or an NVM device or whole NVM device for each neural network applications. The utilization of the rapt memory driver 302 enables the neural network applications to access the NVM device directly using load/store CPU instructions.

This NVM device (for example/dev/pmem0) with a certain size (for example 10 GB) is provided to Neural network applications as part of a container. Now NN applications can do reads/writes to this device using NVM related CPU load/store instructions. Furthermore, the method comprises a step 110 of transmitting a plurality of instructions to a persistent memory aware file system with the MMU mappings, and then the instructions are transmitted to the persistent unit. The method then includes the step 112 of receiving the reading and writing input-output (I/O) request from the persistent unit through a Virtual Function I/O (VFIO) driver. The VFIO driver is an input-output memory management unit (IOMMU) agnostic framework for exposing direct device access to the user space, in a secure, IOMMU protected the environment. Further, the VFIO driver allows a safe, non-privileged, and userspace drivers.

The method includes the step 114 of receiving the reading and writing input-output (I/O) request from the Virtual Function I/O (VFIO) driver through direct memory access (DMA). Direct memory access (DMA) allows an input/output (I/O) device to send or receive data directly to or from the primary memory unit, bypassing the CPU to speed up the memory operations. Typically, the process is managed by a chip known as a DMA controller (DMAC). The method then includes the step 116 of receiving the reading and writing input-output (I/O) request from the direct memory access (DMA) through a memory pertaining to one or more coprocessors.

Typically, the persistent memory architecture involves reads/writes written directly as bytes (typically 64 bytes) using CPU load/store instructions directly to a memory device without any page cache. The present method leverages this feature of the persistent memory and maps the neural network file read/write and transmits it to a persistent memory device. Additionally, the present method directly maps the memory in the persistent memory device to coprocessor's memory using VFIO and DMA.

FIG. 2 illustrates an operational flowchart 200 of the present byte addressable memory system for a neural network, in accordance with at least one embodiment. In operation, the neural network application 204 reads and writes the file I/O operation. The file is accessed by using standard POSIX APIs 206. The file is mapped to persistent memory 208 using “load/store” CPU instructions. Then the bytes are mapped to rapt memory driver 210 which is carved out of PMEM device/DRAM 212. The instructions are sent to a persistent memory aware file system 214 with MMU mappings 216 and sent to PMEM device 212. Then the I/O request (read/write) is picked by VFIO driver 218. The I/O request is sent using DMA 220 and received by the coprocessor's memory 222.

FIG. 3 illustrates an exemplary flowchart 300 of the Rapt.ai byte addressable neural network container, in accordance with at least one embodiment. The rapt memory driver 302 creates a memory device in a host operating system (OS). The persistent memory is configured for a file system using a fourth extended file system (ext4) 304 to create a persistent memory file system on the memory device. In an embodiment, the neural network container 202 receives a memory mapped library 306 from the memory device to train and inference the neural network.

Thus the present invention provides byte addressable direct access training and inference in the neural network container to speed up the neural network training and inference in memory speed compared to current solutions which are blocked based, and speed is slow like accessing a disk.

While embodiments of the present disclosure have been illustrated and described, it will be clear that the disclosure is not limited to these embodiments only. Numerous modifications, changes, variations, substitutions, and equivalents will be apparent to those skilled in the art, without departing from the scope of the disclosure, as described in the claims.

What is claimed is:

1. A computer-implemented method for providing a byte addressable memory for a neural network, the method comprising steps of:
initiating reading and writing input-output (I/O) request of a file through a neural network application;
accessing the file through a portable operating system interface (POSIX) APIs;
mapping the accessed file to a plurality of bytes of a primary memory unit by utilizing a plurality of load/store CPU instructions, wherein the primary memory unit is a persistent memory;
mapping the bytes to a secondary memory unit through a memory management unit (MMU), wherein the secondary memory unit is created from a persistent unit;
transmitting a plurality of instructions to a persistent memory aware file system with the MMU mappings and then the instructions are transmitted to the persistent unit;
receiving the reading and writing input-output (I/O) request from the persistent unit through a Virtual Function I/O (VFIO) driver;
receiving the reading and writing input-output (I/O) request from the Virtual Function I/O (VFIO) driver through a direct memory access (DMA); and
receiving the reading and writing input-output (I/O) request from the direct memory access (DMA) through a memory pertaining to one or more coprocessors.

2. The method according to claim 1, wherein the neural network application, the portable operating system interface (POSIX) APIs, and the persistent memory are contained in a neural network container.

3. The method according to claim 1, wherein the secondary memory unit is a rapt memory driver.

4. The method according to claim 1, wherein the rapt memory driver creates a memory device in a host operating system (OS).

5. The method according to claim 1, wherein the persistent memory is configured for a file system using a fourth extended file system (ext4) to create a persistent memory file system on the memory device.

6. The method according to claim 1, wherein the neural network container receives a memory mapped library from the memory device to train and inference the neural network.

7. A byte addressable memory system for a neural network, the system comprises:
a processor; and
a memory to store machine-readable instructions that when executed by the processor cause the processor to:
initiate reading and writing input-output (I/O) request of a file through a neural network application;
access the file through a portable operating system interface (POSIX) APIs;
map the accessed file to a plurality of bytes of a primary memory unit by utilizing a plurality of load/store CPU instructions, wherein the primary memory unit is a persistent memory;
map the bytes to a secondary memory unit through a memory management unit (MMU), wherein the secondary memory unit is created from a persistent unit;
transmit a plurality of instructions to a persistent memory aware file system with the MMU mappings, and then the instructions are transmitted to the persistent unit;
receive the reading and writing input-output (I/O) request from the persistent unit through a Virtual Function I/O (VFIO) driver;
receive the reading and writing input-output (I/O) request from the Virtual Function I/O (VFIO) driver through a direct memory access (DMA); and
receive the reading and writing input-output (I/O) request from the direct memory access (DMA) through a memory pertaining to one or more coprocessors.

8. The system according to claim 1, wherein the neural network application, the portable operating system interface (POSIX) APIs, and the persistent memory are contained in a neural network container.

9. The system according to claim 1, wherein the secondary memory unit is a rapt memory driver.

10. The system according to claim 1, wherein the rapt memory driver creates a memory device in a host operating system (OS).

11. The system according to claim 1, wherein the persistent memory is configured for a file system using a fourth extended file system (ext4) to create a persistent memory file system on the memory device.

12. The system according to claim 1, wherein the neural network container receives a memory mapped library from the memory device to train and inference the neural network.

13. A device in a network, comprising:
a non-transitory storage device having embodied therein one or more routines operable to provide a byte addressable memory for a neural network; and
one or more processors coupled to the non-transitory storage device and operable to execute the one or more routines, wherein the one or more routines comprises steps of:
initiating reading and writing input-output (I/O) request of a file through a neural network application;
accessing the file through a portable operating system interface (POSIX) APIs;
mapping the accessed file to a plurality of bytes of a primary memory unit by utilizing a plurality of load/store CPU instructions, wherein the primary memory unit is a persistent memory;
mapping the bytes to a secondary memory unit through a memory management unit (MMU), wherein the secondary memory unit is created from a persistent unit;
transmitting a plurality of instructions to a persistent memory aware file system with the MMU mappings and then the instructions are transmitted to the persistent unit;
receiving the reading and writing input-output (I/O) request from the persistent unit through a Virtual Function I/O (VFIO) driver;
receiving the reading and writing input-output (I/O) request from the Virtual Function I/O (VFIO) driver through a direct memory access (DMA); and
receiving the reading and writing input-output (I/O) request from the direct memory access (DMA) through a memory pertaining to one or more coprocessors.

14. The device according to claim 1, wherein the neural network application, the portable operating system interface (POSIX) APIs, and the persistent memory are contained in a neural network container.

15. The device according to claim 1, wherein the secondary memory unit is a rapt memory driver.

16. The device according to claim 1, wherein the rapt memory driver creates a memory device in a host operating system (OS).

17. The device according to claim 1, wherein the persistent memory is configured for a file system using a fourth extended file system (ext4) to create a persistent memory file system on the memory device.

18. The device according to claim 1, wherein the neural network container receives a memory mapped library from the memory device to train and inference the neural network.
